(19) United States
(12) Patent Application Publication
(10) Pub. No.: US 2025/0298675 A1
(43) Pub. Date: Sep. 25, 2025

(54) SCHEDULING METHOD AND DEVICE AND ELECTRONIC DEVICE

(71) Applicant: Lenovo (Beijing) Limited, Beijing (CN)

(72) Inventor: Ming LU, Beijing (CN)

(21) Appl. No.: 19/085,707

(22) Filed: Mar. 20, 2025

(30) Foreign Application Priority Data
Mar. 21, 2024 (CN) 202410330108.0

(51) Int. Cl. G06F 9/50

(52) U.S. Cl. CPC G06F 9/5077; G06F 9/505; G06F 9/5083

(57) ABSTRACT

A scheduling method is applied to cloud services. The scheduling includes determining at least one target node in a target cluster, the target cluster including at least two nodes, each node including a host machine and at least one virtual machine connected to the host machine; determining a scheduling strategy for the virtual machine in the at least one target node, the scheduling strategy being used to schedule the virtual machine connected to the host machine in the target node; and reducing a frequency of the host machine in the target node based on the scheduling strategy.

### CROSS-REFERENCES TO RELATED APPLICATION

This application claims priority to Chinese Patent Application No. 202410330108.0 filed on Mar. 21, 2024, the entire content of which is incorporated herein by reference.

### FIELD OF TECHNOLOGY

The present disclosure relates to the field of information processing and, more specifically, to a scheduling method and device, and an electronic device.

### BACKGROUND

When a server is attacked or is in extreme weather conditions, the power system and air conditioning load of the cloud computing center will increase significantly as the power consumption and heat dissipation of the data center are often related to the central process unit (CPU) load. The higher the CPU load, the greater the heat dissipation. Correspondingly, the air conditioning requirements of the computer room are higher, which further increases the overall power load of the computer room.

To ensure the operation of key systems, cloud computing platform administrators may shut down some non-critical businesses to ensure the operation of key businesses. This will cause the service level of some non-critical businesses to decline.

Therefore, when the power consumption of the data center is high, there is a need to reduce the power consumption of the servers in the data center while maintaining business operations.

### SUMMARY

One aspect of this disclosure provides a scheduling method applied to cloud services. The method includes determining at least one target node in a target cluster. The target cluster includes at least two nodes, and each node includes a host machine and at least one virtual machine connected to the host machine. The method further includes determining a scheduling strategy for the virtual machine in the at least one target node. The scheduling strategy is used to schedule the virtual machine connected to the host machine in the target node. The method further includes reducing the frequency of the host machine in the target node based on the scheduling strategy.

Another aspect of the present disclosure provides a scheduling device applied to cloud services. The device includes a first determination module, a second determination module and a controller. The first determination module is configured to determine at least one target node in the target cluster. The target cluster includes at least two nodes, and each node includes a host machine and at least one virtual machine connected to the host machine. The second determination module is configured to determine a scheduling strategy for the virtual machine in the at least one target node The scheduling strategy is used to schedule the virtual machine connected to the host machine in the target node. The controlling is configured to reduce the frequency of the host machine in the target node based on the scheduling strategy.

Another aspect of this disclosure provides an electronic device. The electronic device includes one or more processors and a memory coupled to the one or more processors and storing computer program instructions. The computer program instruction, when being executed, cause the one or more processors to determine at least one target node in a target cluster. The target cluster includes at least two nodes, and each node includes a host machine and at least one virtual machine connected to the host machine. The one or more processors are also configured to determine a scheduling strategy for the virtual machine in the at least one target node. The scheduling strategy is used to schedule the virtual machine connected to the host machine in the target node. The one or more processors are also configured to reduce the frequency of the host machine in the target node based on the scheduling strategy.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a flowchart of a scheduling method according to some embodiments of the present disclosure.

FIG. 2 is a flowchart of a method of determining at least one target node in a target cluster according to some embodiments of the present disclosure.

FIG. 3 is a flowchart of the method of determining at least one target node in the target cluster according to some embodiments of the present disclosure.

FIG. 4 is a flowchart of the method of determining at least one target node in the target cluster based on a scheduling objective and a preset node scheduling rule according to some embodiments of the present disclosure.

FIG. 5 is a flowchart of a method of reducing the frequency of a host machine in the target node based on a scheduling strategy according to some embodiments of the present disclosure.

FIG. 6 is flowchart of the method of reducing the frequency of the host machine in the target node based on the scheduling strategy according to some embodiments of the present disclosure.

FIG. 7 is a flowchart of the scheduling method according to some embodiments of the present disclosure.

FIG. 8 is a schematic structural diagram of a scheduling device according to some embodiments of the present disclosure.

### DETAILED DESCRIPTION

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

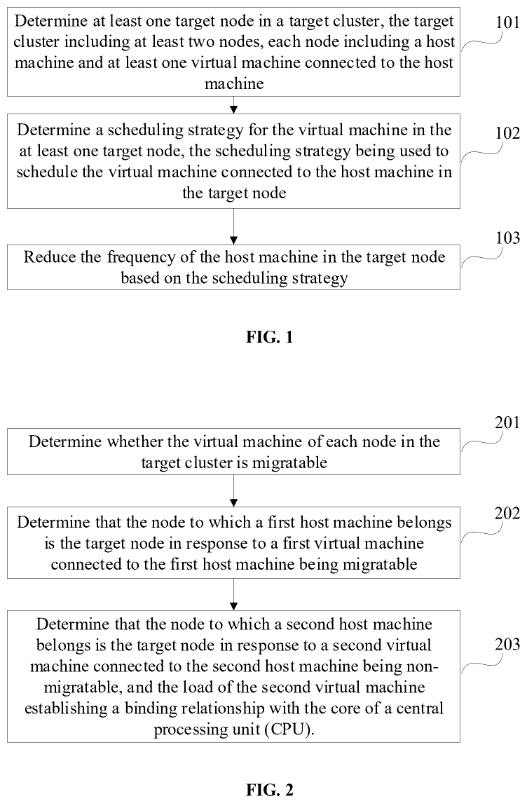

FIG. 1 is a flowchart of a scheduling method according to some embodiments of the present disclosure. The method can be applied to a cloud service device, which includes a target cluster consisting of several nodes. The method will be described in detail below.

101, determining at least one target node in a target cluster, the target cluster including at least two nodes, each node including a host machine and at least one virtual machine connected to the host machine.

The technical solutions of the present disclosure may be triggered based on an event trigger, a manual trigger, and a timing trigger.

In some embodiments, the event trigger can be based on a certain event, which may be an event such as the overall power consumption of the cloud service exceeding a certain set threshold, or the temperature of the data center exceeding a certain temperature threshold under the air conditioning power condition of the cloud service data center. When the trigger event occurs, the technical solutions of the present disclosure can be executed.

In some embodiments, the timing trigger can be based on a set timing trigger. For example, on days with extremely high temperature, every day from 11 am to 6 pm, the technical solutions of the present disclosure can be executed.

In some embodiments, the manual trigger can be triggered manually based on the situation, and can be triggered based on receiving a specific key instruction.

In some embodiments, the target cluster may be a cluster consisting of multiple nodes in the same space or multiple nodes in different spaces. Each node may include a host machine connected to one or more virtual machines (VMs).

In some embodiments, the target node can be determined in the cloud service cluster. The target node may be a node whose power consumption will be reduced in the future to reduce the power consumption of the entire cluster and the temperature of the data center.

In some embodiments, whether the virtual machine in the host machine is migratable may be used as a rule for determining the target node. The method of determining the target node will be described in detail in conjunction with FIG. 2.

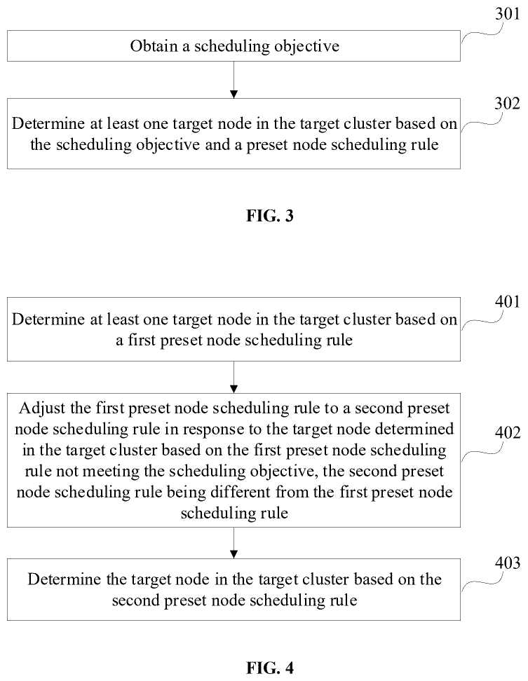

In some embodiments, the target node may be determined based on a scheduling objective and a node scheduling rule. The method of determining the target node will be described in detail in conjunction with FIG. 3.

102, determining a scheduling strategy for the virtual machine in the at least one target node, the scheduling strategy being used to schedule the virtual machine connected to the host machine in the target node.

In some embodiments, after the target nodes in the target cluster are determined, a scheduling strategy for the virtual machines in each target node may be determined.

The scheduling strategy of each virtual machine may be determined based on the preset scheduling rules of the host machines and virtual machines in each node.

103, reducing the frequency of the host machine in the target node based on the scheduling strategy.

After determining the scheduling strategy of the virtual machines in the target node, the corresponding virtual machines can be scheduled based on the scheduling strategy, and the frequency of the host machine in the target node can be reduced after the scheduling is completed to reduce the power consumption of the target node.

In some embodiments, if the virtual machines in some nodes cannot be migrated, their operating frequencies may be directly reduced to reduce power consumption.

In some embodiments, the scheduling strategy may realize the deployment of high-load virtual machines in different cabinets to facilitate heat dissipation and help the operation of related services to be more reliable.

Since most non-critical applications have low daily load, this scheduling strategy can ensure operation of the virtual machines, although the speed may be relatively slow. The overall user experience is ensured.

In some embodiments, the load of the virtual machine may be predicted in advance, especially the load of the virtual machine in the time interval where the scheduling strategy is required. For large and heavily loaded virtual machines, the host machine performing the frequency and voltage regulation can be scheduled in advance. By pre-scheduling, that is, performing the needed mutual exclusion operations, virtual machines with heavy load that can take frequency and voltage reduction can be scheduled in advance.

In some embodiments, after the current scheduling operation is completed, these heavy-load large-size virtual machines may be marked as eligible for frequency and voltage reduction, but cannot be executed within the scope of the current scheduling plan. That is, after pre-scheduling is implemented, the virtual machines are prevented from being repeatedly scheduled.

Consistent with the present disclosure, the target cluster includes at least two target nodes, each of which includes a host machine and at least one virtual machine connected to the host machine. At least one target node in the target cluster can be determined, and a scheduling strategy for the virtual machine in at least one target node can be determined. The scheduling strategy can be used to schedule the virtual machine connected to the host machine in the target node. Based on the scheduling strategy, the frequency of the host machine in the target node can be reduced. At least some nodes in the cluster of cloud service devices can be determined for scheduling and frequency reduction of the host machine. Accordingly, the power consumption of the node to which the host machine belongs is reduced, thereby reducing the risk of extreme weather to the cloud computing data center to which the cloud service equipment belongs. By scheduling the virtual machines and reducing the frequency of the host machine, the business is not shut down, keeping the business running.

FIG. 2 is a flowchart of a method for determining at least one target node in the target cluster according to some embodiments of the present disclosure. The method will be described in detail below.

201, determining whether the virtual machine of each node in the target cluster is migratable.

In some embodiments, whether the virtual machine in a certain node is migratable may be reflected by whether the migration cost is appropriate. If the migration cost is low, the virtual machine can be determined as migratable. Otherwise, the virtual machine cannot be migrated.

The migration cost may be determined by the scheduling duration of the virtual machine, which may be calculated based on the load of the virtual machine, the size of the virtual machine, the load of the host machine, and resource competition conditions.

In some embodiments, a scheduling duration threshold may be set. If the scheduling duration of the virtual machine is less than the scheduling duration threshold, the migration cost of the virtual machine is low; otherwise, the migration cost of the virtual machine is high.

In some embodiments, whether the virtual machine of a node is migratable may be agreed on in advance, and the agreed migration condition may be related to a subsequent preset node scheduling rule.

In some embodiments, based on the node scheduling rule, whether the virtual machine connected to the host machine in a node is migratable may be determined.

For example, the scheduling rule of the node may be: some nodes cannot perform cross-node dynamic migration due to call resource constraints; the dynamic migration time of some nodes is too long and the failure rate is high, migration is not recommended; some nodes are of high business importance and migration is not recommended; migration of some nodes may cause network interruption, which may affect application, and migration is not recommended; the application performance of some nodes degrades significantly after frequency and voltage reduction, migration is not recommended.

The virtual machines in the nodes that meet the scheduling rule of the nodes can be determined as un-schedulable.

202, determining that the node to which a first host machine belongs is the target node in response to a first virtual machine connected to the first host machine being migratable.

In some embodiments, if it is determined that a virtual machine connected to a host machine is migratable, the node to which the host machine belongs can be determined as the target node, and the virtual machine in the host machine of the target node will be subsequently migrated to reduce the frequency of the host machine.

203, determining that the node to which a second host machine belongs is the target node in response to a second virtual machine connected to the second host machine being non-migratable, and the load of the second virtual machine establishing a binding relationship with the core of a central processing unit (CPU).

In some embodiments, if it is determined that a virtual machine connected to a certain host machine is not migratable, then whether the load of the virtual machine can establish a binding relationship with the core of the CPU may be determined.

In some embodiments, if the load of the virtual machine can establish a binding relationship with the core of the CPU, then the node to which the host machine belongs may be determined as the target node.

Subsequently, the virtual machine can be bound to the core of the CPU based on the load, and the scheduling process can be implemented by scheduling the core to reduce the frequency of the host machine in the node.

Consistent with the present disclosure, whether the virtual machines of each node in the target cluster is migratable can be determined. Based on the fact that the first virtual machine connected to the first host machine is migratable, the node to which the first host machine belongs can be determined as the target node. Based on the fact that the second virtual machine connected to the second host machine is not migratable, and the load of the second virtual machine can establish a binding relationship with the core of the CPU, the node to which the second host machine belongs can be determined as the target node. If the virtual machine in the node cannot be migrated, whether the load can establish a binding relationship with the core of the CPU can be determined to realize the process of determining the target node.

FIG. 3 is a flowchart of the method of determining at least one target node in the target cluster according to some embodiments of the present disclosure. The method will be described in detail below.

301, obtaining a scheduling objective.

In some embodiments, the scheduling objective may be set based on the situation of the cloud computing data center to which the target cluster belongs.

In some embodiments, the objective of the current target cluster scheduling may be determined based on manually input conditions or threshold conditions.

More specifically, the scheduling objective may include one or more of: completing resource scheduling and CPU frequency and voltage reduction adjustments in the shortest time; minimizing the impact on the virtual machines or application scale; and minimizing the impact of applications on user experience (that is, the priority is given to frequency and voltage reduction adjustments for applications that are not sensitive to the CPU calculations).

It should be noted that since the migration scheduling efficiency of some virtual machines is relatively slow, the scheduling time may also be a constraint on the scheduling plan of job operation.

In some embodiments, the scheduling objective may also include a scheduling execution method. For example, whether to perform a one-time scheduling or a gradual scheduling, etc.

More specifically, a one-time scheduling method proposes a frequency scheduling method for virtual machines and host machines. Manual determination or no determination is required, and execution is performed. The scheduling will be performed once only unless the next scheduling plan and manual confirmation process is initiated. The gradual scheduling method proposes a step-by-step scheduling method that is goal orientated. After the scheduling is completed, the process will stay for several minutes to determine whether to start the next scheduling, until no scheduling solution can be found (i.e., no solution), or the system power consumption is reduced to a safe level after scheduling, that is, the job is completed.

302, determining at least one target node in the target cluster based on the scheduling objective and a preset node scheduling rule.

In some embodiments, the preset node scheduling rule may include a cluster overall dimension scheduling rule and a node dimension scheduling rule.

In some embodiments, the overall dimension scheduling rule may include:
1. Ensure that a certain type of server runs stably without any changes.

For example, key production virtual machines and applications need to keep running. Certain types of host machines and virtual machines are allowed to perform minimal power reduction operations, and certain types of host machines and virtual machines are allowed to be shut down to reduce power consumption.

It should be noted that power consumption may be reduced for certain types of servers, but the minimum operating frequency or application experience cannot be lower than the threshold of a certain predetermined indicator.
2. Certain scope of virtual machine resource scheduling is allowed (or not allowed).

In some embodiments, considering the business continuity of some key production systems, some heterogenous computing services cannot migrated. For example, graphics processing unit (GPU)/field-programmable gate array (FPGA) services are not suitable for scheduling; if some nodes have been scheduled for a short time, if there are other nodes that can be scheduled, it is best not to schedule these nodes frequently, etc.
3. Different scheduling efficiency strategies.

For example, an aggressive scheduling can first be performed to reduce overall power consumption, then the power consumption can be gradually increased; or, a power consumption reduction strategy can be implemented step-by-step to gradually observe and reduce the power consumption; or, the host frequency and power consumption can be reduced first, then the virtual machine scheduling can be performed; or, the power consumption of virtual machines and applications of different importance levels can be reduced to a certain extent based on a certain pre-made strategy, then further scheduling can be performed based on the overall power consumption changes of the data center, the air conditioning power consumption, and the ambient temperature.
4. During the execution of the power reduction strategy, execution of the simultaneous scheduling plan or the prohibited scheduling plan is allowed.

During the execution of the power consumption reduction scheduling strategy, if other scheduling plans are executed at the same time, it may lead to conflicts in rules and objectives between different scheduling plans, which may render the technical solutions of the present disclosure to be invalid and even create risks to the platform operation. Therefore, there is a need to determine the scope of the load scheduling method that prohibits, allows, or accepts queued requests during the execution of the scheduling method.
5. After different types of loads perform frequency and voltage reduction actions, perform the processing strategy for virtual machine CPU resource competition.

For example, if a virtual machine reports that the steal time (the percentage of time a virtual machine process waits for its CPU time on a physical CPU) is too high, the processing strategy in a frequency and voltage reduction environment is to maintain the status quo, increase the host machine frequency, or perform resource scheduling.

In some embodiments, due to the different characteristics of each cloud computing node, the scheduling rules for different nodes and applications may be different.

For example, it is difficult to perform live migration operations on artificial intelligence programs running on CPUs and GPUs; changes to an application or data cluster require unified changes to the entire cluster, rather than just changes to some nodes.

In addition, the overall dimension scheduling rule may also include:
6. The application clusters running in the virtual machines need to run in different host machines, that is, there are anti-affinity or mutual exclusion constraints.
7. The application clusters are sensitive or insensitive to the frequency and voltage reduction adjustments.
8. Since the size or load of each node in the cluster is relatively large, it is not recommended to perform scheduling operations on the cluster. Instead, only some nodes are scheduled.
9. The amount of concurrency in the cluster is limited.

In some embodiments, the amount of concurrency in the cluster is limited to prevent dish and network congestion.

In some embodiments, limiting the amount of concurrency in the cluster may include: limiting the number of nodes that can be scheduled simultaneously in the cluster to no more than x, x being a positive integer; limiting the number of nodes that can be migrated out and in at the same time; limiting the number of other cloud platform devices such as those connected via network switches.

It should be noted that the numbers in the above cluster overall dimension scheduling rules only indicate different rules that can be adopted, and do not represent the order of execution or determination.

In some embodiments, the node dimension scheduling rule may include:
1. Some nodes cannot perform cross-node dynamic migration due to call resource constraints.
2. The dynamic migration of some nodes takes too long and has a high failure rate, and migration is not recommended.
3. Some nodes are of high business importance and migration is not recommended.
4. Migration of some nodes may cause network interruption, which in turn affects application, and migration is not recommended.
5. After frequency and voltage reduction is performed, the application performance of some nodes will significantly reduce, and migration is not recommended.
6. The number of nodes that can be scheduled simultaneously within the cloud platform does not exceed x, x being a positive integer.

In some embodiments, the preset node scheduling rule may include the scheduling start time and end time.

For example, a schedule starts at a certain time and executes for x minutes, and the current resource scheduling process will be completed at a certain time.

It should be noted that the numbers in the above node dimension scheduling rules only indicate different rules that can be adopted, and do not represent the order of execution or determination.

During implementation, the preset node scheduling rule may also include:
1. For the host machine with reduced frequency and voltage, a virtual machine steal time abnormal alarm may be triggered. The alarm threshold may maintain the threshold of the normal operating environment and perform scheduling, or no scheduling may be performed in this time window. Alternatively, the steal time alarm condition for virtual machines with lower importance may be increased.

For example, if the steal time exceeds 15% for four consecutive monitoring data collections, an alarm will be triggered and a scheduling operation between downclocked host machines will be triggered.
2. If the response time of an application virtual machine or database server exceeds a certain threshold, its scheduling will be performed on other host machines with less frequency and voltage reduction and lower host machine load.

In combination with the above scheduling objective and the preset node scheduling rule, at least one target node can be determined in the target cluster to schedule the target node and reduce the frequency of the host machine to reduce the power consumption of the target node.

It should be noted that the numbers in the above preset node scheduling rules only indicate different rules that can be adopted, and do not represent the order of execution or determination.

In some embodiments, the properties of the node or target cluster may be recorded in a database or configuration file, such as a configuration management database. The application may obtain relevant information by accessing the database or configured file.

In addition, some cloud platform-related databases, such as OpenStack NOVA-related databases or configuration management databases (CMBDs), may also store resource dependencies, for example, certain virtual machines run on certain host machines. This data is also needed for scheduling.

In some embodiments, the information needed for scheduling may also include whether different nodes are affected by the CPU instruction set and whether these nodes are migratable; whether different nodes can be migrated based on their functions, such as whether they carry production or not; the need for mutually exclusive operation between migrated nodes, etc.

The information needed for the above scheduling is part of the preset node scheduling rules.

In addition, which strategy a node or application needs to run may also be marked and recorded in the corresponding database.

The typical markings include whether frequency and voltage reduction is allowed or not; the lower limit of the highest frequency supported during business peaks.

In some embodiments, in the CPU on-demand scheduling mode, the maximum CPU frequency can be set. Some applications have certain requirements for responding to the maximum CPU frequency, therefore, there is a need to mark the lower limit of the maximum frequency supported by the business peak.

In some embodiments, since the cloud computing resource pool is relatively small, there may be no feasible solution. Therefore, different constraints may be merged or executed in certain order or strategy to obtain a feasible solution for optimal scheduling.

In some embodiments, if the target node that meets the scheduling objective cannot be obtained based on the node scheduling rule, the node scheduling rule may be adjusted until the target node that meets the scheduling objective is obtained. The method of determining the target node based on the scheduling objective and the preset node scheduling rules is described in conjunction with FIG. 4.

Consistent with the present disclosure, by obtaining the scheduling objective, and determining the target node in the target cluster based on the scheduling objective and the preset node scheduling rule, the process of determining the target node based on the scheduling rule and scheduling objective is realized in view of the scheduling rule. Accordingly, the target node is scheduled and frequency reduction is performed, thereby adjusting the power consumption in the target cluster.

FIG. 4 is a flowchart of the method of determining at least one target node in the target cluster based on a scheduling objective and the preset node scheduling rule according to some embodiments of the present disclosure. The method will be described in detail below.

401, determining at least one target node in the target cluster based on a first preset node scheduling rule.

In some embodiments, a target node in the target cluster may be determined to achieve an optimal solution for scheduling the target cluster.

In some embodiments, after determining to schedule the target cluster, the first preset node scheduling rule may be obtained, and the target node may be determined in the target cluster based on the first preset node scheduling rule. In addition, the scheduling method for each target node may also be determined.

However, if the determined target node and the scheduling method of the target node cannot meet the scheduling objective, the current scheduling will fail to achieve its purpose, and current scheduling is determined to be a failure. Therefore, there is a need to adjust the node scheduling rule.

In some embodiments, the first preset node scheduling rule may be first executed, and during the execution of the first preset node scheduling rule, whether the operation of the target cluster meets the scheduling objective can be determined. If the operation of the target cluster does not meet the scheduling objective, the process at 402 can be executed.

402, adjusting the first preset node scheduling rule to a second preset node scheduling rule in response to the target node determined in the target cluster based on the first preset node scheduling rule not meeting the scheduling objective, the second preset node scheduling rule being different from the first preset node scheduling rule.

In some embodiments, if the target node determined based on the first preset node scheduling rule does not meet the scheduling objective, the node scheduling rule may be adjusted from the first preset node scheduling rule to the second preset node scheduling rule.

In some embodiments, since the cloud computing resource pool is relatively small, there may be no feasible solution and the scheduling objective may not be met. Therefore, different constraints may be merged or executed in certain order or strategy to obtain a feasible solution for optimal scheduling

In some embodiments, the adjustment may be made by adjusting the cluster overall dimension scheduling rule. The cluster overall dimension scheduling rule can be considered as a soft constraint, and the adjustment can be made based on the soft constraint.

More specifically, a single soft constraint can be adjusted based on a prefabricated strategy, or multiple soft constraints may be adjusted simultaneously.

For example, the start and end time of the job plan may be adjusted (i.e., extending the resource scheduling duration), the range of host machine levels for frequency and voltage reduction may be adjusted, some frequency and voltage reduction levels may be merged, etc.

In some embodiments, importance level of different virtual machines may be set. For example, the lower the importance level, the higher the importance.

For example, if the nodes other than the non-schedulable nodes or nodes that are unsuitable for frequency and voltage reduction can be adjusted from level 5 to level 2, then all host machines from level 2 to level 5 and below can be made schedulable. By adjusting the soft constraints, a wider range of resources can be scheduled, and a feasible solution can be obtained.

In some embodiments, an importance level can be set for each virtual machine. When selecting the target node, whether the virtual machine connected to its host machine is schedulable and whether frequency reduction can be performed may be determined, and the scheduling can start from the virtual machine in which frequency and voltage reduction can be performed. Subsequently, scheduling can be carried out step by step towards the level that cannot be scheduled.

In some embodiments, if no feasible solution is obtained in a virtual machine at a certain level, the virtual machines at that level may be merged upwards, and more virtual machines within a higher importance level can be determined for selection to achieve scheduling.

403, determining the target node in the target cluster based on the second preset node scheduling rule.

In some embodiments, after adjusting the preset node scheduling rule, the target node can be determined in the target cluster based on the adjusted second preset node scheduling rule, and the scheduling objective can be met by scheduling the re-determined target node.

Consistent with the present disclosure, at least one target node can be determined in the target cluster based on the first preset node scheduling rule; if the target node determined in the target cluster based on the first preset node scheduling rule does not meet the scheduling objective, the first preset node scheduling rule can be adjusted to the second preset node scheduling rule, the second preset node scheduling rule being different from the first preset node scheduling rule; the target node can be determined in the target cluster based on the second preset node scheduling rule. By adjusting the node scheduling rule, the resource range of scheduling is expanded, and the scheduling strategy corresponding to the target node is optimized.

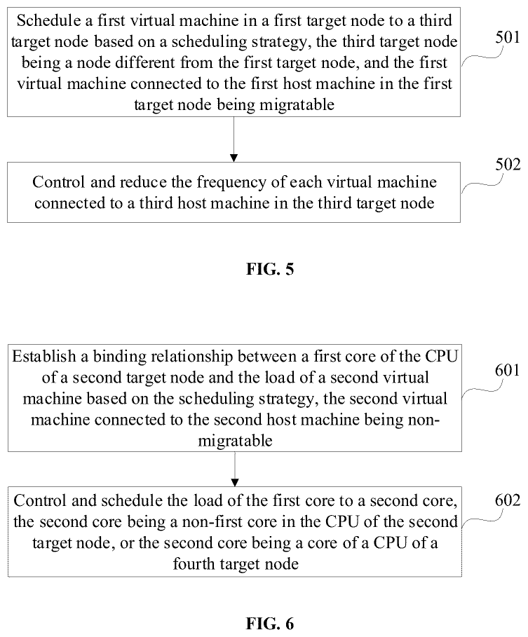

FIG. 5 is a flowchart of a method of reducing the frequency of a host machine in the target node based on a scheduling strategy according to some embodiments of the present disclosure. The method will be described in detail below.

501, scheduling a first virtual machine in a first target node to a third target node based on a scheduling strategy, the third target node being a node different from the first target node, the first virtual machine connected to the first host machine in the first target node being migratable.

In some embodiments, when it is determined that the virtual machine in the first target node can be migrated and the third target node can receive the migrated virtual machine, the virtual machine in the first target node may be scheduled to the third target node.

Correspondingly, the resources occupied by the first virtual machine may also be scheduled to the third target node, thereby reducing the power consumption of the first target node.

In some embodiments, if the CPU frequency in the first target node cannot be reduced, its virtual machine may be scheduled to the other target nodes to reduce the power consumption of the first target node.

In some embodiments, after scheduling the virtual machine in the first target node to other target nodes, if the CPU frequency in the first target node can be reduced, the frequency in the first target node may also be reduced to further reduce the power consumption of the first target node.

502, controlling and reducing the frequency of each virtual machine connected to a third host machine in the third target node.

In some embodiments, if the frequency in the third target node can be reduced, the frequency of each virtual machine connected to the host machine in the third target node may be controlled to be reduced to reduce the power consumption of the third target node.

In some embodiments, the power consumption at the first target node may be reduced by simply controlling the first virtual machine in the first target node to be secluded to the third target node.

In some embodiments, to reduce the overall power consumption, the frequency of each virtual machine connected to the host machine in the third target node may be controlled to reduce the power consumption at the third target node.

Consistent with the present disclosure, the first virtual machine connected to the first host machine in the first target node can be scheduled to the third target node based on the scheduling strategy, the third target node being a node different from the first target node, and the first virtual machine in the first target node being migratable; and the frequency of each virtual machine connected to the third host machine in the third target node can be controlled and reduced. By migrating the migratable virtual machine in a target node to other target nodes, the scheduling of the target node can be realized. In addition, the frequency of the virtual machine in the other target node can be reduced, thereby reducing the power consumption of the other target node.

FIG. 6 is flowchart of the method of reducing the frequency of the host machine in the target node based on the scheduling strategy according to some embodiments of the present disclosure. The method will be described in detail below.

601, establishing a binding relationship between a first core of the CPU of a second target node and the load of a second virtual machine based on the scheduling strategy, the second virtual machine connected to the second host machine being non-migratable.

In some embodiments, if the virtual machine connected to the host machine in a target node is not migratable, the load of the virtual machine may be bound to the core of the CPU of the target node to realize CPU isolation to gradually complete the dynamic scheduling of resources.

In some embodiments, the binding relationship may implement load scheduling for the virtual machine that is non-migratable.

602, controlling and scheduling the load of the first core to a second core, the second core being a non-first core in the CPU of the second target node, or the second core being a core of a CPU of a fourth target node.

In some embodiments, the load of the first core that establishes a binding relationship with the load of the second virtual machine may be controlled and scheduled to the second core.

Since some nodes do not perform dynamic migration, in some embodiments, the CPU isolation may be combined with frequency and voltage reduction to accelerate the overall scheduling efficiency.

In some embodiments, during the scheduling process, if some virtual machines have completed scheduling, but some have not, the load bound to the CPU core of a host machine may be migrated to the CPU core of another host machine. The CPU core of the other host machine may be a CPU core that carries virtual machine services that can reduce frequency and voltage, and the CPU core of the other host machine may perform the corresponding frequency and voltage reduction operations.

Consistent with the present disclosure, a binding relationship can be established between the first core of the CPU of the second target node and the load of the second virtual machine based on the scheduling strategy, the second virtual machine connected to the second host machine being non-migratable; and the load of the first core ca be controlled and scheduled to the second core, the second core being a non-first core in the CPU of the second target node, or the second core being a core of a CPU of a fourth target node. By binding the load of the non-migratable virtual machine to the first core of the CPU, the load bound to the first core can be scheduled to other cores, such as other cores of the target node or cores of other target nodes. Accordingly, the process of migrating the load of the non-migratable virtual machine in the second target node is realized to reduce the load of the second target node.

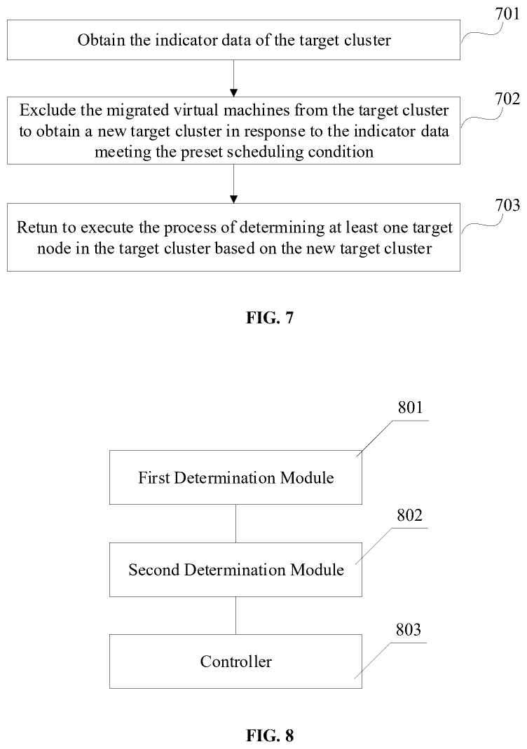

FIG. 7 is a flowchart of the scheduling method according to some embodiments of the present disclosure. Based on the flowchart shown in FIG. 1, after the process at 103, the method may further include the following processes.

701, obtaining the indicator data of the target cluster.

In some embodiments, the scheduling of the target cluster may be a one-time scheduling or a plurality of scheduling.

In some embodiments, for one-time scheduling, the scheduling plan may be output once. The determined scheduling strategy may be used to generate a scheduling plan, and the scheduling may be performed once based on the scheduling plan.

In some embodiments, for a step-by-step scheduling plan, each time a scheduling plan is generated, the scheduling process may be monitored during the scheduling process to regenerate a new scheduling plan and adjust the scheduling process.

More specifically, a new scheduling plan may be generated after scheduling is completed based on a previous scheduling plan, or a new scheduling plan may be generated during the scheduling process.

In some embodiments, during the scheduling process or after scheduling is completed, the indicator data of the target cluster may be obtained.

More specifically, relevant indicator data of the data center of the target cluster may be obtained.

In some embodiments, the indicator data may be analyzed to determine whether it meets a preset scheduling condition. If so, the next scheduling will be triggered, otherwise, the scheduling ends.

More specifically, the preset scheduling condition may be set based on actual needs, representing the condition under which the scheduling can be stopped. The scheduling condition may be set based on actual needs, which is not limited in the embodiments of the present disclosure.

In some embodiments, the preset scheduling condition may correspond to the scheduling objective. The system power consumption can be reduced to a safe level as long as the scheduling objective is met.

702, excluding the migrated virtual machines from the target cluster to obtain a new target cluster in response to the indicator data meeting the preset scheduling condition.

In some embodiments, when scheduling is needed again, the virtual machines that were scheduled last time may be excluded, and a new scheduling plan may be generated based on the virtual machines connected to the remaining host machines in the target cluster.

For example, the target cluster includes three host machines a, b and c, each of which is connected to three virtual machines. This time, scheduling is performed for virtual machines a1 and b1. The cluster after excluding virtual machines a1 and b1 can be used as the new target cluster.

703, retuning to execute the process of determining at least one target node in the target cluster based on the new target cluster.

In some embodiments, after determining the new target cluster, the scheduling plan may be determined in the new target cluster. For the scheduling process, reference can be made to the relevant description in the foregoing embodiments. The scheduling process can be stopped when the operation condition that meets the scheduling stop condition appears.

In some embodiments, a condition for ending the scheduling may be set in advance. For example, when the environmental conditions require the end of the scheduling of frequency reduction process. The present disclosure does not limit the condition for ending the scheduling.

Correspondingly, the cloud platform load may be restored to normal operation through the following processes.
1. Restoring the CPU frequency of each host machine node to normal levels.
2. Collecting and monitoring data of the target cluster, virtual machines, and application within a certain period of time, and performing scheduling work for nodes with resource competition. For example, when the steal time of the virtual machines is too high and lasts for a period of time.

Consistent with the present disclosure, the indicator data of the target cluster can be obtained; the virtual machines that have been migrated can be excluded from the target cluster to obtain a new target cluster in response to the indicator data meeting the preset scheduling condition; and the process of determining at least one target node in the target cluster can be executed based on the new target cluster. By setting the preset scheduling condition, the timing of executing the scheduling strategy in steps to trigger the next scheduling strategy can be determined, thereby ensuring that the resources in the target cluster can be scheduled in steps.

Corresponding to the above scheduling method embodiment, the present disclosure also provides a device embodiment for applying the scheduling method.

FIG. 8 is a schematic structural diagram of a scheduling device according to some embodiments of the present disclosure. As shown in FIG. 8, the scheduling device includes a first determination module 801, a second determination module 802 and a controller 803.

In some embodiments, the first determination module 801 may be configured to determine at least one target node in a target cluster, the target cluster including at least two nodes, each of which including a host machine and at least one virtual machine connected to the host machine.

In some embodiments, the second determination module 802 may be configured to determine a scheduling strategy for the virtual machine in the at least one target node, the scheduling strategy being used to schedule the virtual machine connected to the host machine in the target node.

In some embodiments, the controller 803 may be configured to reduce the frequency of the host machine in the target node based on the scheduling strategy.

In some embodiments, the first determination module 801 may include a monitoring unit and a first determination unit. The monitoring unit may be configured to detect whether the virtual machine of each node in the target cluster can be migrated. The first determination unit may be configured to determine that a node to which the first host machine belongs is a target node based on the first virtual machine connected to the first host machine being migratable; determine that the node to which a second host machine belongs is the target node in response to a second virtual machine connected to the second host machine being non-migratable, and the load of the second virtual machine being able to establish a binding relationship with the core of the central processing unit (CPU).

In some embodiments, the first determination module 801 may include an acquisition unit and a second determination unit. The acquisition unit may be configured to obtain a scheduling objective. The second determination unit may be configured to determine at least one target node in the target cluster based on the scheduling objective and the preset node scheduling rule.

In some embodiments, the second determination unit may be configured to determine at least one target node in the target cluster based on a first preset node scheduling rule; adjust the first preset node scheduling rule to a second preset node scheduling rule in response to the target node determined in the target cluster based on the first preset node scheduling rule not meeting the scheduling objective, the second preset node scheduling rule being different from the first preset node scheduling rule; determine the target node in the target cluster based on the second preset node scheduling rule.

In some embodiments, the controller may include a first scheduling unit. The scheduling unit may be configured to schedule the first virtual machine in the first target node to a third target node based on the scheduling strategy, the third target node being a node different from the first target node, and the first virtual machine in the first target node being migratable.

In some embodiments, the controller may also include a control unit. The control unit may be configured to control and reduce the frequency of each virtual machine connected to the third host machine in the third target node.

In some embodiments, the controller may also include a binding unit and a second scheduling unit. The binding unit may be configured to establish a binding relationship between the first core of the CPU of the second target node and the load of the second virtual machine based on the scheduling strategy, the second virtual machine connected to the second host machine being non-migratable. The second scheduling unit may be configured to control the scheduling of the load of the first core to the second core, the second core being a non-first core in the CPU of the second target node, or the second core being a core of the CPU of the fourth target node.

In some embodiments, the scheduling device may also include an acquisition module and a third determination module. The acquisition module may be configured to obtain the indicator data of the target cluster after reducing the frequency of the host machine in the target node based on the scheduling strategy. The third determination module may be configured to exclude the virtual machines that have been migrated from the target cluster to obtain a new target cluster based on whether the indicator data meets the preset scheduling condition, and trigger the first determination module based on the new target cluster.

It should be noted that for the details of the structure and function of the scheduling device provided in the device embodiment, reference can be made to the relevant description in the foregoing method embodiments, which will not be repeated here.

Consistent with the present disclosure, the target cluster includes at least two target nodes, each of which includes a host machine and at least one virtual machine connected to the host machine. At least one target node in the target cluster can be determined, and a scheduling strategy for the virtual machine in at least one target node can be determined. The scheduling strategy can be used to schedule the virtual machine connected to the host machine in the target node. Based on the scheduling strategy, the frequency of the host machine in the target node can be reduced. At least some nodes in the cluster of cloud service devices can be determined for scheduling and frequency reduction of the host machine. Accordingly, the power consumption of the node to which the host machine belongs is reduced, thereby reducing the risk of extreme weather to the cloud computing data center to which the cloud service equipment belongs. By scheduling the virtual machines and reducing the frequency of the host machine, the business is not shut down, keeping the business running.

Corresponding to the scheduling method embodiments of the present disclosure, the present disclosure further provides an electronic device and readable storage medium corresponding to the scheduling method.

The electronic device can include a memory and a processor.

The memory can store a processing program.

The processor can be configured to load and execute the processing program stored in the memory to implement the steps of any one of the scheduling methods above.

For the execution of the scheduling method by the electronic device, reference can be made to the scheduling method embodiments above.

The readable storage medium can store a computer program, which can be called and executed by the processor to implement the steps of any one of the scheduling method embodiments above.

For the execution of the scheduling method by the computer program stored in the readable storage medium, reference can be made to the scheduling method embodiments above.

In the present specification, the embodiments are described in a gradual and progressive manner with the emphasis of each embodiment on an aspect different from other embodiments. The same or similar parts among the various embodiments may refer to each other. Since the disclosed device embodiment corresponds to the disclosed method embodiment, detailed description of the disclosed device is omitted, and reference can be made to the description of the methods for a description of the relevant parts of the device.

The foregoing description of the disclosed embodiments will enable a person skilled in the art to realize or use the present disclosure. Various modifications to the embodiments will be apparent to those skilled in the art. The general principles defined herein may be implemented in other embodiments without departing from the spirit or scope of the disclosure. Accordingly, the disclosure will not be limited to the embodiments shown herein, but is to meet the broadest scope consistent with the principles and novel features disclosed herein.

What is claimed is:

1. A scheduling method, applied to cloud services, comprising:
determining at least one target node in a target cluster, the target cluster including at least two nodes, each node including a host machine and at least one virtual machine connected to the host machine;
determining a scheduling strategy for the virtual machine in the at least one target node, the scheduling strategy being used to schedule the virtual machine connected to the host machine in the target node; and
reducing a frequency of the host machine in the target node based on the scheduling strategy.

2. The scheduling method of claim 1, wherein determining at least one target node in the target cluster includes:
detecting whether the virtual machine of each node in the target cluster is migratable;
determining that the node to which a first host machine belongs to is the target node in response to a first virtual machine connected to the first host machine being migratable; and
determining that the node to which a second host machine belongs to is the target node in response to a second virtual machine connected to the second host machine being non-migratable, and a load of the second virtual machine being able to establish a binding relationship with a core of a central processing unit (CPU).

3. The scheduling method of claim 1, wherein determining at least one target node in the target cluster includes:
obtaining a scheduling objective; and
determining at least one target node in the target cluster based on the scheduling objective and a preset node scheduling rule.

4. The scheduling method of claim 3, wherein determining at least one target node in the target cluster based on the scheduling objective and the preset node scheduling rule includes:
determining at least one target node in the target cluster based on a first preset node scheduling rule;
adjusting the first preset node scheduling rule to a second preset node scheduling rule in response to the target node determined in the target cluster based on the first preset node scheduling rule not meeting the scheduling objective, the second preset node scheduling rule being different from the first preset node scheduling rule; and
determining the target node in the target cluster based on the second preset node scheduling rule.

5. The scheduling method of claim 1, wherein reducing the frequency of the host machine in the target node based on the scheduling strategy includes:
scheduling the first virtual machine in a first target node to a third target node, the third target node being a node different from the first target node based on the scheduling strategy, the first virtual machine connected to the first host machine in the first target node being migratable.

6. The scheduling method of claim 5, further comprising:
controlling and reducing the frequency of each virtual machine connected to the host machine in the third target node.

7. The scheduling method of claim 1, wherein reducing the frequency of the host machine in the target node based on the scheduling strategy includes:
establishing the binding relationship between a first core of the CPU of a second target node and the load of the second virtual machine based on the scheduling strategy, the second virtual machine connected to the second host machine being non-migratable; and
controlling and scheduling the load of the first core to a second core, the second core being a non-first core in the CPU of the second target node, or the second core being a core of the CPU of a fourth target node.

8. The scheduling method of claim 1, wherein reducing the frequency of the host machine in the target node based on the scheduling strategy further includes:
obtaining indicator data of the target cluster;
excluding the migrated virtual machines from the target cluster to obtain a new target cluster in response to the indicator data meeting a preset scheduling condition; and
returning to execute the process of determining the at least one target node in the target cluster based on the new target cluster.

9. The scheduling device, applied to cloud services, comprising:
a first determination module, the first determination module being configured to determine at least one target node in the target cluster, the target cluster including at least two nodes, each node including a host machine and at least one virtual machine connected to the host machine;
a second determination module, the second determination module being configured to determine a scheduling strategy for the virtual machine in the at least one target node, the scheduling strategy being used to schedule the virtual machine connected to the host machine in the target node; and
a controller, the controlling being configured to reduce a frequency of the host machine in the target node based on the scheduling strategy.

10. An electronic device comprising:
one or more processors; and
a memory coupled to the one or more processors and storing computer program instructions that, when being executed, cause the one or more processors to:
determine at least one target node in a target cluster, the target cluster includes at least two nodes, each node including a host machine and at least one virtual machine connected to the host machine;
determine a scheduling strategy for the virtual machine in the at least one target node the scheduling strategy being used to schedule the virtual machine connected to the host machine in the target node; and
reduce a frequency of the host machine in the target node based on the scheduling strategy.

11. The electronic device of claim 10, wherein the one or more processors are further configured to:
detect whether the virtual machine of each node in the target cluster is migratable;
determine that the node to which a first host machine belongs to is the target node in response to a first virtual machine connected to the first host machine being migratable; and
determine that the node to which a second host machine belongs to is the target node in response to a second virtual machine connected to the second host machine being non-migratable, and a load of the second virtual machine being able to establish a binding relationship with a core of a central processing unit (CPU).

12. The electronic device of claim 10, wherein the one or more processors are further configured to:
obtain a scheduling objective; and
determine at least one target node in the target cluster based on the scheduling objective and a preset node scheduling rule.

13. The electronic device of claim 12, wherein the one or more processors are further configured to:
determine at least one target node in the target cluster based on a first preset node scheduling rule;
adjust the first preset node scheduling rule to a second preset node scheduling rule in response to the target node determined in the target cluster based on the first preset node scheduling rule not meeting the scheduling objective, the second preset node scheduling rule being different from the first preset node scheduling rule; and
determine the target node in the target cluster based on the second preset node scheduling rule.

14. The electronic device of claim 10, wherein the one or more processors are further configured to:
schedule the first virtual machine in a first target node to a third target node, the third target node being a node different from the first target node based on the scheduling strategy, the first virtual machine connected to the first host machine in the first target node being migratable.

15. The electronic device of claim 14, wherein the one or more processors are further configured to:
controlling and reducing the frequency of each virtual machine connected to the host machine in the third target node.

16. The electronic device of claim 10, wherein the one or more processors are further configured to:
establish the binding relationship between a first core of the CPU of a second target node and the load of the second virtual machine based on the scheduling strategy, the second virtual machine connected to the second host machine being non-migratable; and
control and scheduling the load of the first core to a second core, the second core being a non-first core in the CPU of the second target node, or the second core being a core of the CPU of a fourth target node.

17. The electronic device of claim 10, wherein the one or more processors are further configured to:
obtain indicator data of the target cluster;
exclude the migrated virtual machines from the target cluster to obtain a new target cluster in response to the indicator data meeting a preset scheduling condition; and
return to execute the process of determining the at least one target node in the target cluster based on the new target cluster.
